(19) United States
(12) Patent Application Publication
(10) Pub. No.: US 2010/0138728 A1
(43) Pub. Date: Jun. 3, 2010

(54) APPARATUS FOR SUPPORTING DYNAMIC CHANGE OF EVENT RULE UNDER SCA AND METHOD THEREOF

(75) Inventors: Hongsoog KIM, Daejeon-City (KR); Namhoon Park, Daejeon-City (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-City (KR)

(21) Appl. No.: 12/629,834

(22) Filed: Dec. 2, 2009

(30) Foreign Application Priority Data
Dec. 3, 2008 (KR) 10-2008-0121647
Aug. 31, 2009 (KR) 10-2009-0081385

(51) Int. Cl. G06F 11/07; G06F 9/46; G06N 5/02

(52) U.S. Cl. 714/799; 719/318; 706/47; 706/59; 714/E11.024

(57) ABSTRACT

An apparatus according to the present invention is an apparatus for supporting dynamic change of event rules in an SDR terminal under an SCA. The apparatus for supporting dynamic change of event rules includes: an event rule DB storing the rules that replicate event signals from an event generator and transmits the replicated event signals to an event consumer; an event manager that updates an event rule table recorded in a domain by using the event rules stored in the event rule DB; and an event relay unit that replicates the event signals from the event generator based on the event rule table and transmits the replicated event signals to the corresponding event consumer.

### RELATED APPLICATIONS

The present application claims priority to Korean Patent Application Serial Number 10-2008-0121647, filed on Dec. 3, 2008 and Korean Patent Application Serial Number 10-2009-0081385, filed on Aug. 31, 2009, the entirety of which are hereby incorporated by references.

### BACKGROUND OF THE INVENTION

1. Field of the Invention

The present invention relates to an apparatus for supporting a dynamic change of event rules under an SCA and an operating method thereof. More specifically, the present invention relates to an apparatus for minimizing unnecessary repeat messages and supporting a dynamic change of event filtering and replicating rules at a domain level under an SCA compliant and an operating method thereof.

2. Description of the Related Art

Currently, technology fusion is the most important change in factors that characterize the advancement of technologies according to the development of information communication. In addition, the change in demands of users, who have used a mobile terminal mainly for voice, now use various types of multimedia data with one terminal regardless of communication modes, types of networks, and use places. In correspondence to the changes in users' demands, service providers and terminal manufacturers should change new technologies and paradigms that can support various communication protocols including existing communication protocols while being able to rapidly apply new standard protocols or upgrades.

Although the development of wireless communication technologies provides many services using various modes of communication technologies, the interoperability between various communication protocols has degraded. As a result, a need exists for flexible wireless systems. To this end, a study on a software defined radio (SDR) technology, which can integrate and accept a plurality communication protocols using a single transmit and receive system only by efficiently and flexibly changing modular software without correcting hardware, has progressed.

A concept of the SDR is a technology that can permit a system configuration to apply to both the existing system standards and the new system standards by processing signals from the baseband to RF and IF using reconfigurable components such as high-speed DSP, FPGA, etc.

In order to build a system that can be flexibly applied in various wireless access environments, the SDR technology, which can perform global communication that does not need to be stopped when downloading application software having an object directional structure on a single hardware platform having an opened type structure, is considered as a system building technology that flexibly provides multiple standards, multiple processing frequency, and various services with one system in order to accept various standards present on the market for mobile communication.

The SDR can be defined as a technology that can integrate various modes of wireless communication services, which use different devices in the related art, by changing only the software not the hardware. In other words, the SDR may be the new communication technology that can implement various communication units, such as xDSL, CDMA, GSM, UMTS, CDMA 2000, WLAN, Bluetooth, satellite communication, etc., as well as the existing 2G and 3G, in one terminal. Therefore, when the SDR is commercialized, services, which can be provided by various devices, such as a mobile phone, a PCS, a WLAN, etc., can be provided by changing only the software in the SDR terminal. In addition, the SDR enables a user's terminal to provide global roaming, which can receive services anywhere in the world.

Meanwhile, the SDA mobile communication terminals and base stations use a software communication architecture (SCA) compliant. In the SCA compliant, when events, that generate components configuring applications, are required in both the IDM channel and the ODM channel, the component, which is an event producer, should generate the same events for each event channel. As another method usable under the current SCA compliant, an event consumer for the corresponding events should perform a role of the event producer that replicates events to be consumed by the event consumer to generate events to other channels.

However, both cases described above have problems in that the events are unnecessarily overlap and communication traffic may be increased when the event producer is far away from the event consumer. The overlapped events do not generate any problems in equipment such as a base station that has abundant computing/network resources. However, the overlapped events become a load in equipment such as a mobile terminal due to limited computing/network resources, such that a problem in reducing operational speed necessary to perform inherent functions can be caused.

In addition, since the event consumer should implement operation control mechanisms such as event filtering that chooses and uses only the desired events among events generated in the domains, event replication when there are a plurality of event consumers, etc., there is a problem in managing the domains.

When the event consumer implements the event filtering/replicating functions, the event filtering/replicating functions are fixed depending on the functions implemented by the event consumer, such that it is not easy to change the event filtering/replicating functions. Further, since the event filtering/replicating functions essentially correspond to the management functions at the domain level, there occurs a problem in that a subject of implementing the functions is inconsistent.

### SUMMARY OF THE INVENTION

The present invention proposes to solve the above problems.

An object of the present invention is to prevent degradation in communication performance due to repeated transmission of the same events and increase an operational speed in equipment such as a mobile terminal that have limited computing/network resources, by using an event relay unit that is operated as an upper event channel of an ODM channel and an IDM channel and performs a relay function and dynamic filtering and replicating functions at a domain level under an SCA compliant.

Another object of the present invention is to dynamically change event rules during the operation of the applications by preventing a transmitting function through filtering or replicating of the events from being fixed to a specific object as well as universally and flexibly achieving event filtering, replicating, and transmitting, etc., which are generated in the domains, by designating a frequency of event filtering or an event consumer.

There is provided an apparatus for supporting dynamic change of event rules in an SDR terminal under an SCA according to the present invention, including: an event rule DB storing the event rules that replicate event signals from an event generator and transmits the replicated event signals to an event consumer; an event manager that updates an event rule table recorded in a domain by using the event rules stored in the event rule DB; and an event relay unit that replicates the event signals from the event generator based on the event rule table and transmits the replicated event signals to the corresponding event consumer.

The event relay unit replicates the event signals from the event generator and transmits the replicated event signals to the corresponding event consumer by using at least one of an OMD channel and an IDM channel.

The event management unit updates the event rule table when the event relay unit starts to operate.

The event management unit updates the event rule table when the contents of the event rules stored in the event rule DB are changed.

The event management unit includes a controller that outputs the event signals for stopping and resuming the operation of the event relay unit to the event relay unit.

The controller outputs the event signals for stopping the operation of the event relay unit to the event relay unit when the contents of the event rules stored in the event rule DB are changed.

The event management unit includes an event rule grammar checking unit that checks grammatical errors of the event rules stored in the event DB.

The event management unit includes an event rule semantic checking unit that checks semantic errors of the event rules stored in the event DB.

The event management unit includes a storage unit that stores information on the history of replication and transmission of the event signals in the event relay unit.

The apparatus for supporting dynamic change of event rules further includes a controller that provides information on the history of replication and transmission of the event signals in the event relay unit to a domain client.

The event rules include information on the event consumer that receives the replicating frequency of the event signals and the event signals.

The event rule DB and the event management unit are implemented outside the domain.

There is provided a method for operating an apparatus for supporting dynamic change of event rules including an event rule DB, an event management unit, and an event relay unit in an SDR terminal under an SCA, wherein the event management unit includes: determining whether the contents of the event rules stored in the event rule DB are changed; checking grammar errors and semantic errors of the event rules when the contents of the event rules are changed; outputting event signals for stopping the operation of the event relay unit and stopping the operation of the event relay unit when the event rules does not grammatically and semantically have errors; updating an event rule table recorded in a domain by using the event rules stored in the event rule DB; and outputting the event signals for resuming the operation to the event relay unit and resuming the operation of the event relay unit when the update of the event rule table is completed.

The method for operating an apparatus for supporting dynamic change of event rules, further includes: receiving and storing information on the history of replication and transmission of the event signals in the event relay unit from the event relay unit.

The method for operating an apparatus for supporting dynamic change of event rules, further includes: providing information on the history of replication and transmission of the event signals in the event relay unit to the domain client.

The event rules include information on the event consumer receiving the replicating frequency of the event signals and the event signals.

The event relay unit includes: receiving the event signals from the event generator and determining the types of input event signals; selecting the event rules corresponding to the input event signals in the event rule table; and replicating the event signals from the event generator based on the selected event rule and transmitting the replicated event signals to the corresponding event consumer.

The replicating the event signals and transmitting the replicated event signals to the corresponding event consumer are performed using at least one of an ODM channel and an IDM channel.

The method for operating an apparatus for supporting dynamic change of event rules according to claim 13, wherein the event rule table is recorded in a memory in the domain.

The present invention has the following effects.

The present invention can prevent the degradation in communication performance due to repeated transmission of the same event and increase the operational speed in equipment such as the mobile terminal that has limited computing/network resources. In addition, the present invention can flexibly describe the specifications of the event consumers and specify the replicating frequency or the event consumer to facilitate the designation thereof.

Further, the present invention can commonly or separately control filtering, replicating and transmitting of events, etc., which are generated in the plurality of domains within the SCA.

Moreover, the present invention arranges the event rule DB outside the domain and if necessary, uses the event rules recorded in the event rule DB to update the event rule table, making it possible to dynamically change the event rules during the operation of the applications.

### BRIEF DESCRIPTION OF THE DRAWINGS

FIG. 1 is a block diagram for explaining a structure of an SDR terminal under existing SCA compliant;

FIG. 2 is a block diagram for explaining a structure of an SDR terminal under SCA compliant to which an apparatus for supporting a dynamic change of event rules according to the present invention is applied;

FIG. 3 is a reference diagram for explaining the apparatus for supporting a dynamic change of event rules according to the present invention;

FIG. 4 is a block diagram for explaining in more detail a configuration of an event management unit shown in FIG. 2;

FIG. 5 is a flow chart for explaining a method for relaying event signals according to the present invention; and

FIG. 6 is a flow chart for explaining a method of operating the apparatus for supporting a dynamic change of event rules under an SCA according to the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the drawings may be exaggerated for explicit comprehension.

The present invention relates to a method for operating a device manager in a mobile terminal. The embodiment to be described below describes, by way of example, a method for operating a device manager in an SDR terminal under SCA compliant, but is not limited thereto. Therefore, it will be appreciated to those skilled in the art that various modifications are made and other equivalent embodiments can be made.

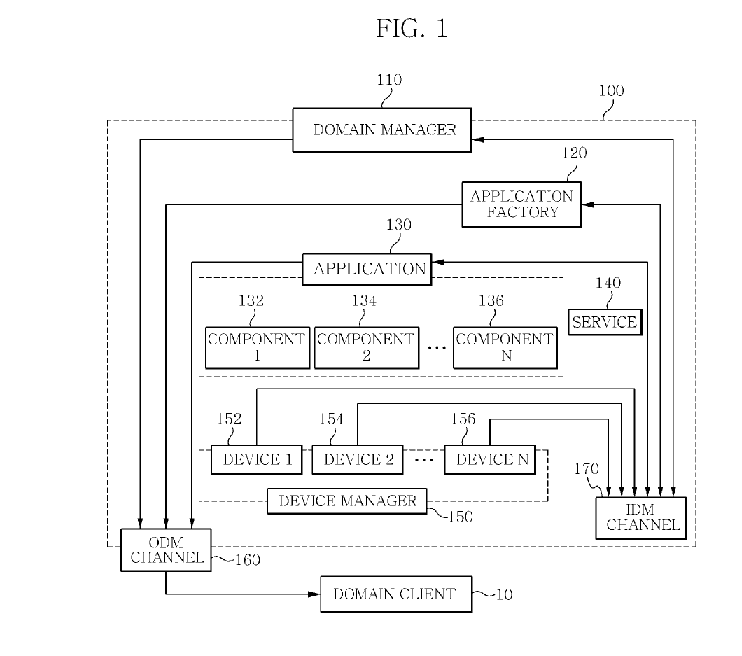

FIG. 1 is a block diagram for explaining a structure of an SDR terminal under an existing SCA.

Although not shown in the drawings, in the SDR terminal, an Operating System (OS), a Common Object Request Broker Architecture (CORBA), and an SCA Core Framework (CF) are disposed on an upper layer of hardware, such as a Central Processing Unit (CPU), a Digital Signal Processor (DSP), or a Field Programmable Gate Array (FPGA).

Herein, one or more domain 100 exists in the SCA core framework. The domain, which is essentially a concept introduced to classify group communication, is used to classify communication protocols, such as land communication, maritime communication, land-maritime communication, etc. For convenience of explanation, the present invention defines ‘domain’ as “a set of communication protocols under the control of one domain manager component”.

As shown in FIG. 1, the domain 100 includes components, such as a domain manager 110, an application factory 120, application 130, a service 140, a device manager 150, and a file manager.

In an SCA compliant, the application 130 is defined as a set of components that are installed and started (perform a unit function of a communication protocol) by allowing the domain manager 110 to use the application factory 120. The application 130, which is a functional unit treating all the communication protocols, is configured of one or more components 132, 134, and 136 that are functional units each performing inherent communication related sub-functions.

Each of the components 132, 134, and 136 configuring the application 130 uses devices 152, 154, and 156, which are processing elements, in order to perform the communication related functions.

The service 140 is a unit that implements commonly necessary service functions (support functions not communication protocols) at an application level. As an example, it may include a log service commonly necessary for several applications.

The domain manager 110 manages the device manager 150, the application 130, the devices 152, 154, and 156, and information on the service 140 component in the domain 100.

In addition, the domain manager 110 uses an application package configured of a component execution file necessary to operate the application 130, a component setting file, a component arrangement information file, etc., to generate the application factory 120. As a result, ‘create( ) operation’ of the application factory 120 loads the components configuring the application 130 in a device designated in the component disposition information file or executes the components.

An outgoing domain management channel (ODM) channel 160, which is an external event channel used to transmit event signals (hereinafter, referred to as ‘event’) generated by a domain management function to the outside, is, for example, used to allow the domain client 10 to receive events generated by the domain management function.

An incoming domain management channel (IDM) 170 is an internal event channel used to transmit the events generated by the domain management function to an event consumer in the domain. In other words, the IDM channel uses the components in the domain in order to generate events consumed by the domain management function.

The SCA compliant defines the events under thirteen situations, which is defined as follows. It should be noted herein that the following event definition is the minimum events required in a system and if necessary, can be used by additionally defining types of events by a user.

1. The application 130 transmits a related event notifying that the application is released to the ODM channel 160 when ‘releaseObject( ) operation’ is successfully performed.

2. The application factory 120 transmits a related event notifying that the generation of application object is successfully performed to the ODM channel 160 when ‘create( ) operation’ is successfully performed.

3. When the device manager 150 managed by the domain manager 110 through ‘registerDeviceManager( ) operation’ call is successfully registered in the domain manager 110, the domain manager 110 transmits a related event notifying it to the ODM channel 160.

4. When the domain manager 110 generates a specific device to the device manager 150 managed by the domain manager 110 through ‘registerDevice( ) operation’ call and successfully registers it, the domain manager 110 transmits a related event notifying it to the ODM channel 160.

5. The domain manager 110 installs a package necessary to execute and configure specific application within the domain 100 managed by the domain manager 110 through ‘installApplication( ) operation’ call. When the corresponding application factory 120 is successfully made, the domain manager 110 transmits a related event to the ODM channel 160 to notify it.

6. When the device manager 150 registered in the domain manager 110 is successfully unregistered from the domain manager 110 through ‘unregisterDeviceManager( ) operation’ call, the domain manager 110 transmits a related event to the ODM channel 160 in order to notify unregistration of the corresponding device manager 150.

7. When the domain manager 110 successfully unregisters the specific device registered in the device manager 150 registered in the domain manager 110 through ‘unregisterDevice( ) operation’ call, the domain manager 110 transmits a related event to the ODM channel 160 in order to notify unregistration of the corresponding device.

8. When the domain manager 110 successfully uninstalls the application factor 120 made by the domain manager 110 through ‘uninstallApplication( ) operation’ call, the domain manager 110 transmits a related event to the OMD channel 160 in order to notify that the installation of the corresponding application factory 120 is released.

9. When the domain manager 110 successfully registers a specific service through ‘registerService( ) operation’ call, the domain manager 110 transmits a related event to the ODM channel 160 in order to notify that the corresponding service is successfully installed.

10. When the domain manager 110 successfully unregisters a pre-registered specific service through ‘unregisterService( ) operation’ call, the domain manager 110 transmits a related event to the ODM channel 160 in order to notify that the corresponding service is successfully unregistered.

11. When the usage status (IDLE, ACTIVE, BUSY) of the devices 152, 154, and 156 registered in the device manager 150 are changed, the devices 152, 154, and 156 transmit a related event to the IDM channel 170 in order to notify it.

12. When the administration status (LOCKED, UNLOCKED, SHUTTING_DOWN) of the devices 152, 154, and 156 registered in the device manager 150 are changed, the devices 152, 154, and 156 transmit a related event to the IDM channel 170 in order to notify it.

13. When the operational status (ENABLED, DISABLED) of the devices 152, 154, and 156 registered in the device manager 150 are changed, the devices 152, 154, and 156 transmit a related event to the IDM channel 170 in order to notify it.

When the events are operated according to the known SCA compliant of the related art, the system does not cope with the following situations or the performance of the system may be degraded due to excess generation of events.

a) A case where the components are replaced during the execution of the application 130:
when some of the components 132, 134, and 136 configuring the application 130 are replaced during the execution of the application 130, the replaced components notify information notifying that the components are replaced to other components needing the information, devices, the device manager, the domain manager, or the domain client 10, which exists in the outside, such as operation and management program through the events.

b) A case where the same event is required in the ODM channel 160 and the IDM channel 170:
for example, when the administration state, operational state, and usage status of the device are changed, the domain manager, the application factory, the applications receive the events transmitted through the IDM channel and update the internal information, in the SCA compliant. However, the external domain client program such as the operation and management program may require the events.

c) Limitation of a transmitting function through filtering or replicating of events that can be implemented:
in the current SCA compliant, the transmitting function through filtering or replicating of the events should be implemented in either the event generator or the event consumer.

In case a), the replaced components should have advance information on the event consumer requiring the information notifying that the components are replaced and even though there is advance information, it should repeatedly transmit the corresponding events as many times as the required number of objects.

In other words, when n objects require the replacement information, n times in order for the replaced components to transmit the related replacement information to the corresponding event channels and n times in order for the event consumer to receive the replacement information from the corresponding event channel, that is, a total of 2n times communications are required.

Further, a method of enabling the replaced components to set and maintain information on the event consumer requiring the replacement information of the components does not exist in the current SCA compliant.

In case b), the current SCA compliant replicates the corresponding events and transmits them to the ODM channel 160 again while the events are consumed in the domain manager 110, the application factory 120, the application 130, etc., which are the event consumer of the IDM channel 170. In this case, however, since the information on the event consumer cannot be described, there are problems in that replicating frequency or the event consumer can be designated.

Finally, in case c), that is, in the case where these functions are implemented in the event generator or the event consumer, since the transmitting function through filtering or replicating of the events is fixedly implemented to the specific object, there is a limit in that the corresponding objects is reused or the transmission rule through filtering or replicating of the events cannot be changed during the operation of the applications.

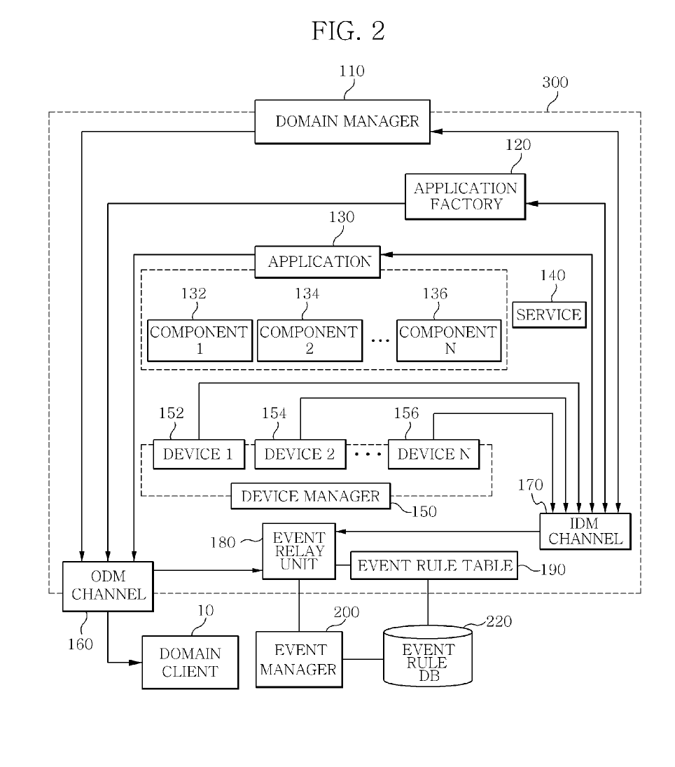

FIG. 2 is a block diagram for explaining a structure of an SDR terminal under an SCA to which an apparatus for supporting a dynamic change of event rules according to the present invention is applied. More specifically, in the structure of the SDR terminal of FIG. 1, an event relay unit 180, which performs a relay role of the IDM channel and the ODM channel and performs the dynamic filtering/replicating functions of the events at the domain level, is additionally provided. Herein, in order to help understand the present invention, like reference numerals refer to components having the same functions and configuration as components shown in FIG. 1 and thus, the description thereof will be omitted.

Hereinafter, the components will be described in more detail with reference to FIG. 2. In FIG. 2, the event relay unit 180 registers itself as an event producer in the IDM channel 170 and the ODM channel 160 for the event replication/transmission to the ODM channel 160 and for the event replication/transmission to the IDM channel 170 when the domain manager 110 starts, in order to relay between the ODM channel 160 and the IDM channel 170.

Therefore, the apparatus for supporting the dynamic change of the event rules according to the present invention can be applied without changing the existing SCA compliant. In other words, the event relay unit 180 is operated as the upper event channels of the ODM channel 160 and the IDM channel 170 while maintaining the existing ODM channel 160 and the IDM channel 170.

The event relay unit 180 filters or replicates the events according to the filtering, replicating, and transmitting rules of the events recorded in an event rule database 220 (hereinafter, referred to as ‘event rule DB’) and transmits them to the event consumer. At this time, the event relay unit 180 performs the operation according an event rule table 190 recorded in the memory of the domain for high-speed operation, wherein the event rule table 190 is prepared and updated based on the filtering, replicating, and transmitting rules of the events stored in the event rule DB 220.

For example, the event rules recorded in the event rule DB 220 may be as follows. When the event signals related to the change in the administration state, operational state, and usage status of the device are transmitted through the IDM channel, the rules can be defined so as to replicate the event signals input to the IDM channel and transmit them to the external domain client through the ODM channel.

Meanwhile, as shown in FIG. 2, the event management unit 200 and the event rule DB 220 of the present invention are implemented outside the domain.

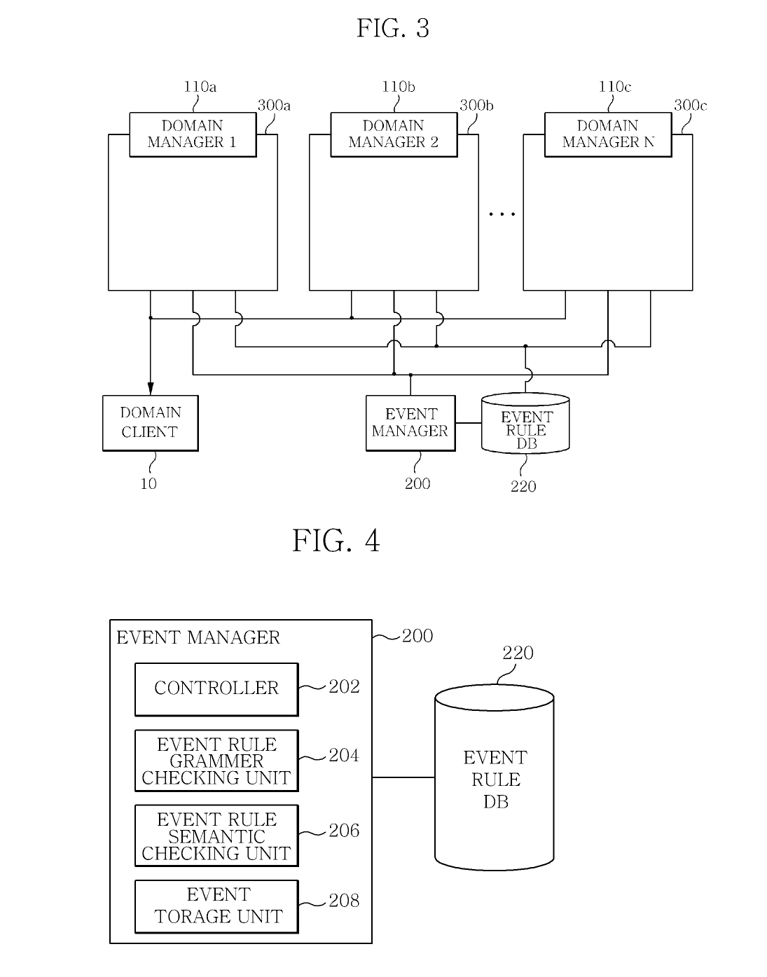

Referring to FIG. 3, there may be one or more domain in the SCA. For example, there may be a plurality of domains 300a, 300b, and 300c to classify each communication protocol such as land communication, maritime communication, and land-maritime communication, and there may be a plurality of managers 110a, 110b, and 110c to manage each domain.

The present invention implements the event manager 200 and the event rule DB 220 in an area outside the domain so that the event manager 200 and the event rule DB 220 do not belong to any specific domain. As a result, the present invention uses one event management unit 200 and one event rule DB 220 to commonly or partially control filtering, replicating, and transmitting, etc., generated in the plurality of domains. In other words, the plurality of domains can be universally and flexibly controlled through the above structure.

In addition, when the event rule DB 220 is implemented outside the domain, the present invention prepares and operates the event rule table 190 in the domain to prevent the delay of the access speed or the collision between the signals that can occur. Thereby, the event relay unit 180 easily accesses the event rule table 190, making it possible to rapidly perform the operations according to the event rules recorded in the event rule table.

Meanwhile, when the components are replaced during the execution of the application 130, the components replaced under the existing SCA compliant should have advance information on the event consumer requiring the replacement information of the components, and even though there is the advance information, it should repeatedly transmit the corresponding events as many times as the required number of objects.

However, with the present invention, since the event rule DB manages the advance information on the event consumer requiring replacement information of the components, the replaced components (that is, the event generator) doesn't have to store and manage the information on the event consumer requiring the replacement information of the components. In addition, since the events are replaced as many times as the number of objects requiring the corresponding events in the event relay unit and are transmitted to the corresponding objects, the replaced components transmit the events to the corresponding event channels once.

Therefore, the present invention can prevent the degradation in communication performance due to the repeated or duplicated transmission of the event and increase the operational speed in equipment such as the mobile terminal that has limited computing/network resources. In addition, since it is easy to change the specification of the event consumer requiring the replacement information of the components, the specification of the event consumer can be flexibly described and the replicating frequency or the event consumer can be uniquely designated.

The event management unit 200 manages and controls the event relay unit 180, the event rule table 190, and the event rule DB 220.

The event management unit 200 reads the filtering, replicating, and transmitting rules of the events corresponding to the event relay unit 180 of the corresponding domain 300 from the event rule DB 220 at the following point in time to prepare or update the event rule table 190.

i. when the operation of the event relay unit 190 starts.

ii. when the contents of the event rules recorded in the event rule DB 220 are changed.

The event management unit 200 monitors whether the contents of the event rules recorded in the event rule DB 220 are changed and when the event rules are changed, transmits a stop event to the event relay unit 180 to stop the operation. The event management unit 200 reads the filtering, replicating, and transmitting rules of the events corresponding to the event relay unit 180 of the corresponding domain 300 from the event rule DB 220 to update the event rule table 190.

The event management unit 200 controls the update of the event rule table 190 and then, transmits the restart event to the event relay unit 180 to resume the operation of the event relay unit 180.

Hereinafter, in order to achieve the foregoing, each component included in the event management unit 200 will be described in more detail with reference to FIG. 4.

The event management unit 200 includes a controller 202, an event rule grammar checking unit 204, an event rule semantic checking unit 206, and an event storage unit 208.

The controller 202 generates the events to stop and resume the operation of the event relay unit 180. More specifically, when the contents of the event rules recorded in the event rule DB 220 are changed, the controller 202 outputs the stop event to the event relay unit 180 and stops the operation of the event relay unit 180. The controller 200 controls the read of filtering, replicating, and transmitting of the events corresponding to the corresponding domain 300 from the event rule DB 220 and to perform the grammar check and the semantic check of the event rules in the event rule grammar checking unit 204 and the event rule semantic checking unit 206. The controller 202 uses the event rules, which do not grammatically and semantically have errors, to update the event rule table 190 and then, outputs the events to resume the operation of the event relay unit 180.

With the foregoing configuration, it is possible to dynamically change the event rules during the operation of the applications. In other words, the present invention arranges the event rule DB 220 outside the domain and if necessary, uses the event rules recorded in the event rule DB 220 to update the event rule table, making it possible to dynamically change the event rules during the application operation.

The event rule grammar checking unit 204 checks the grammatical error of the event rules recorded in the event rule DB 220.

The event rule semantic checking unit 204 checks the semantic errors of the event rules recorded in the event rule DB 220.

The event storage unit 208 receives and stores information on the history of filtering, replicating, and transmitting (for example, data, time, etc.) of the events in the event relay unit 200 from the event relay unit 200. The information on the history of filtering, replicating, and transmitting of the events stored in the event storage unit 208 can be provided according to the request from the periodic or domain client 10 and the domain client 10 uses the information, making it possible to effectively operate and manage the domain.

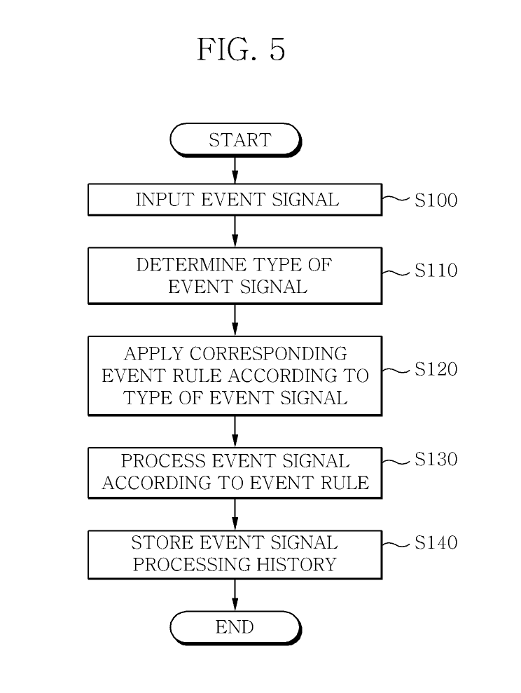

FIG. 5 is a flow chart for explaining a method for relaying event signals according to the present invention.

Referring to FIG. 5, the event relay unit receives the event signals input from the event generator through the ODM channel or the IDM channel (S100) and determines the types of input event signals (S110).

The event rules defined in the event rule table are applied according to the types of input event signals (S120).

For example, when the administration state, operational state, and usage status of the devices are changed, the events are transmitted through the IDM channel and the domain manager, the application factory, and the applications receive the events and update internal information. At this time, the external domain client program such as the operation and management program may require the events. In other words, the case where the same events are transmitted through the ODM channel and the IDM channel may occur.

Therefore, in the present invention, the event relay unit performs a process to receive the event signals input to the IDM channel and replicate the corresponding event signals and to transmit them to the external domain client through the ODM channel. Thereby, the external domain client can receive information on the change in the management state, operational state, and usage status of the devices through the ODM channel.

As described above, the event relay unit receives the event signals input to the ODM channel and the IDM channel, determines the types of corresponding event signals, and applies the corresponding event rules, thereby process (replicating/filtering/transmitting) the corresponding event signals (S130).

Next, the event relay unit performs step S130 and then, transmits the information on the history processing the event signals to the event management unit, such that the event management unit can store the history of the event signals processed in the event relay unit.

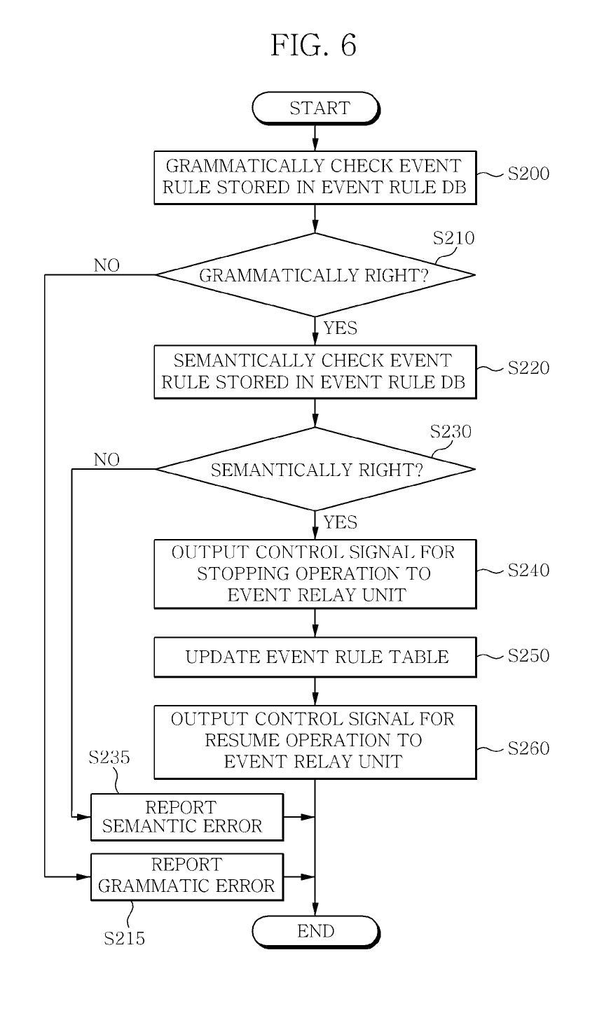

FIG. 6 is a flow chart for explaining a method of operating the apparatus for supporting a dynamic change of event rules under an SCA according to the present invention. More specifically, when the operation of the event relay unit starts, FIG. 6 shows the operational process of the event management unit when the event rule DB is changed and is automatically or manually started by the manager.

First, the event management unit checks whether there are grammatical errors in the event rules stored in the event rule DB (S200).

The event management unit determines whether the event rule stored in the event rule DB is grammatically proper (S210).

As a determination result at step S210, when there are grammatical errors in the event rules stored in the event rule DB, the event management unit reports that there are grammatical errors in the stored event rules and the process ends (S215).

As a check result at step S200, when there are no grammatical errors (grammatically right) in the event rules stored in the event rule DB, the event management unit checks whether there are semantic errors in the contents of the event rules (S220).

The event management unit determines whether the event rule stored in the event rule DB is semantically proper (S230).

As a determination result at step S230, when there are semantic errors in the event rules stored in the event rule DB, the event management unit reports that there are semantic errors in the stored event rules and the process ends (S235).

As a check result at step S230, when there are no semantic errors in the event rules stored in the event rule DB (semantically right), the event management unit outputs the event control signals in order to stop the operations to the event relay unit (S240).

Next, after requesting the stop of operations to the event relay unit and converting the rules described in the text or database form in the event rule DB into the binary memory table information, the event rule table is updated through the predetermined transmission line (S250).

When the update is completed, the event management unit transmits the event control signals for resuming the operations to the event relay unit and resumes the operation of the event relay unit (S260).

The present invention prepares and operates the event rule table in the domain to prevent the delay of the access speed or the collision between the signals, which can be caused when the event rule DB is implemented outside the domain. Thereby, the event relay unit easily accesses the event rule table, making it possible to rapidly perform the operations according to the event rules recorded in the event rule table.

Further, since advance information on the event consumer requiring the replacement information of the components is managed in the event rule DB, the replaced component (that is, event generator) does not store and manage the information on the event consumer requiring the replacement information of the component. In addition, since the events corresponding to the number of objects requiring the corresponding events in the event relay unit are replicated and transmitted to the corresponding objects, the replaced components transmit the events to the corresponding event channels once.

Therefore, the degradation in the communication performance is prevented according to the repeated or duplicated transmission of the same events and the operational speed can be improved in equipment such as the mobile terminal that has limited computing/network resources. In addition, since it is easy to change the specification of the event consumer requiring the replacement information of the components, the specification of the event consumer can be flexibly described and replicating frequencyor the event consumer can be uniquely designated.

In addition, it is possible to dynamically change the event rules during the operation of the applications. In other words, the event rule DB is disposed outside the domain and if necessary, the event rule table is updated using the event rules recorded in the event rule DB, making it possible to dynamically change the event rules during the operation of the applications.

The present invention can be implemented as a computer-readable code in a computer-readable recording medium. The computer-readable recording media includes all types of recording apparatuses in which data readable by a computer system is stored. Examples of the computer-readable recording media may include a ROM, a RAM, a CD-ROM, a magnetic tape, a floppy disk, an optical data storage device, etc. In addition, the computer-readable recording media also include one implemented in the form of a carrier wave (i.e., transmission through the Internet). Further, the computer-readable recording media are distributed on systems connected over the network, and are stored and executed as the computer-readable code by a distribution method.

As described above, the exemplary embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An apparatus for supporting dynamic change of event rules in an SDR terminal under an SCA, comprising:
an event rule DB storing the event rules that replicate event signals from an event generator and transmits the replicated event signals to an event consumer;
an event manager that updates an event rule table recorded in a domain by using the event rules stored in the event rule DB; and
an event relay unit that replicates the event signals from the event generator based on the event rule table and transmits the replicated event signals to the corresponding event consumer.

2. The apparatus for supporting dynamic change of event rules according to claim 1, wherein the event relay unit replicates the event signals from the event generator and transmits the replicated event signals to the corresponding event consumer by using at least one of an OMD channel and an IDM channel.

3. The apparatus for supporting dynamic change of event rules according to claim 1, wherein the event management unit updates the event rule table when the event relay unit starts to operate.

4. The apparatus for supporting dynamic change of event rules according to claim 1, wherein the event management unit updates the event rule table when the contents of the event rules stored in the event rule DB are changed.

5. The apparatus for supporting dynamic change of event rules according to claim 1, wherein the event management unit includes a controller that outputs the event signals for stopping and resuming the operation of the event relay unit to the event relay unit.

6. The apparatus for supporting dynamic change of event rules according to claim 5, wherein the controller outputs the event signals for stopping the operation of the event relay unit to the event relay unit when the contents of the event rules stored in the event rule DB are changed.

7. The apparatus for supporting dynamic change of event rules according to claim 1, wherein the event management unit includes an event rule grammar checking unit that checks grammatical errors of the event rules stored in the event DB.

8. The apparatus for supporting dynamic change of event rules according to claim 1, wherein the event management unit includes an event rule semantic checking unit that checks semantic errors of the event rules stored in the event DB.

9. The apparatus for supporting dynamic change of event rules according to claim 1, wherein the event management unit includes a storage unit that stores information on the history of replication and transmission of the event signals in the event relay unit.

10. The apparatus for supporting dynamic change of event rules according to claim 9, further comprising a controller that provides information on the history of replication and transmission of the event signals in the event relay unit to a domain client.

11. The apparatus for supporting dynamic change of event rules according to claim 1, wherein the event rules include information on the event consumer that receives the replicating frequency of the event signals and the event signals.

12. The apparatus for supporting dynamic change of event rules according to claim 1, wherein the event rule DB and the event management unit are implemented outside the domain.

13. A method for operating an apparatus for supporting dynamic change of event rules including an event rule DB, an event management unit, and an event relay unit in an SDR terminal under an SCA, wherein the event management unit includes:
determining whether the contents of the event rules stored in the event rule DB are changed;
checking grammar errors and semantic errors of the event rules when the contents of the event rules are changed;
outputting event signals for stopping the operation of the event relay unit and stopping the operation of the event relay unit when the event rules do not grammatically and semantically have errors;
updating an event rule table recorded in a domain by using the event rules stored in the event rule DB; and
outputting the event signals for resuming the operation to the event relay unit and resuming the operation of the event relay unit when the update of the event rule table is completed.

14. The method for operating an apparatus for supporting dynamic change of event rules according to claim 13, further comprising: receiving and storing information on the history of replication and transmission of the event signals in the event relay unit from the event relay unit.

15. The method for operating an apparatus for supporting dynamic change of event rules according to claim 14, further comprising: providing information on the history of replication and transmission of the event signals in the event relay unit to the domain client.

16. The method for operating an apparatus for supporting dynamic change of event rules according to claim 13, wherein the event rules include information on the event consumer receiving the replicating frequency of the event signals and the event signals.

17. The method for operating an apparatus for supporting dynamic change of event rules according to claim 13, wherein the event relay unit includes:
receiving the event signals from the event generator and determining the types of input event signals;
selecting the event rules corresponding to the input event signals in the event rule table; and
replicating the event signals from the event generator based on the selected event rule and transmitting the replicated event signals to the corresponding event consumer.

18. The method for operating an apparatus for supporting dynamic change of event rules according to claim 17, wherein the replicating the event signals and the transmitting the replicated event signals to the corresponding event consumer are performed using at least one of an ODM channel and an IDM channel.

19. The method for operating an apparatus for supporting dynamic change of event rules according to claim 13, wherein the event rule table is recorded in a memory of the domain.
